(19) United States
(12) Patent Application Publication
(10) Pub. No.: US 2026/0134796 A1
(43) Pub. Date: May 14, 2026

(54) BRAILLE DISPLAY CELL SYSTEM

(71) Applicant: Thinkerbell Labs Private Limited, Bengaluru (IN)

(72) Inventors: Saif Ali Shoukat Ali SHAIKH, Mumbai (IN); Jagadish Sai Varma KUNADHARAJU, Bhimavaram (IN); Yugandhar GUPTA DURGI, Sullurpeta (IN); Aditya GARG, Ambala (IN); Sanjith VENKATESHA, Bangalore (IN); Dilip RAMESH, Bengaluru (IN)

(73) Assignee: Thinkerbell Labs Private Limited, Bengaluru (IN)

(21) Appl. No.: 19/384,626

(22) Filed: Nov. 10, 2025

(30) Foreign Application Priority Data
Nov. 8, 2024 (IN) 202441086082

(51) Int. Cl. G09B 21/02

(52) U.S. Cl. CPC G09B 21/02

(57) ABSTRACT

A refreshable braille display cell system, comprising: a cell case with a reading surface, the reading surface comprising a plurality of holes and guideways; a plurality of braille pins, the plurality of braille pins comprising a tactile tip and a foot, wherein the foot comprises a planar surface extruding orthogonal to the plurality of braille pins; a plurality of rotary actuators, the plurality of rotary actuators configured to rotate a shaft in clockwise and counter clockwise directions; and a plurality of composite cam, the plurality of composite cam comprising a profiled curved surface configured to interact with the foot of the plurality of braille pins; wherein rotation of the plurality of composite cam implement linear movement of the plurality of braille pins between a raised position and a recessed position.

### RELATED APPLICATIONS

This application claims priority to Indian Application No. 202441086082, filed Nov. 8, 2024, which is hereby incorporated herein by reference in its entirety.

### TECHNICAL FIELD

The present invention relates to a Braille display cell system for visually impaired people. More specifically, the present invention provides a refreshable Braille display cell system for assisting visually impaired people or sighted people to learn or understand and read Braille.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Braille is a system of touch reading and writing for blind persons in which raised dots represent the letters of the alphabet. It can be read either on embossed paper or by using refreshable braille displays that can dynamically display braille characters and can be connected to computers or mobile phones. Braille can be written using a slate and stylus, a braille writer, an electronic braille notetaker or with the use of a computer connected to a braille embosser. Braille characters are formed using a combination of six raised dots arranged in a 3×2 matrix, called the braille display cell. The number and arrangement of these dots distinguish one character from another. Generally, 6-dots in a Braille allows for a total of 64 combinations wherein letters, contraction and punctuation marks are mapped. These mappings may vary from language to language. Braille has been extended to an 8-dot code, particularly for use with braille embossers, refreshable braille displays and computers. In 8-dot braille two additional dots are added at the bottom of the cell, giving a matrix 4 dots high by 2 dots wide.

A refreshable braille display or braille terminal is an electro-mechanical device for displaying braille characters, usually by means of round-tipped pins raised through holes in a flat surface. Visually impaired computer users who cannot use a standard computer monitor can use it to read text output. A refreshable braille display contains braille display cells wherein each cell contains either 6 or 8 dots with each cell capable of displaying a character by selectively raising or lowering the pins pertaining to the dot combination of that character. The pins are raised or lowered electromechanically and are controlled by a microcontroller.

The majority of refreshable Braille displays available today rely on piezoelectric biomorph reeds for dot actuation. Alternative technologies under research include systems utilizing shape memory alloys, electro-rheological fluids, solenoids, electroactive polymers, and microfluidic or pneumatic micro-valves. Additional mechanisms such as rotating disks, micro-step motors, vibration motors, electrothermal and electromagnetic actuators, and low-melting-point metal-based systems have also been explored for Braille display applications.

Moreover, the rods or dots that protrude above the reading surface have a very low holding force i.e. when a user pushes them down even with the marginal forces these dots would recede back into the surface. The dots not being held or locked in their raised position could make it difficult to read braille for beginners who are not proficient with their braille reading skills or for adults suffering from neuropathy on their fingertips who would struggle from reading pins that can recede while reading. This technology is still very expensive, which in turn puts such Braille display devices beyond the reach of most of the visually impaired people, especially those belonging to developing nations.

U.S. Pat. No. 9,812,033B2 discloses a tactile graphic display method comprising of the display includes one or more frame assemblies including hollow actuator chambers and hollow shaft chambers, the hollow shaft chambers extending perpendicular to the hollow actuator members. Actuators are received within the plurality of hollow actuator chambers and drive shafts are received with the hollow shaft members. Cams operably connect the actuators to the drive shafts. Each actuator rotates each cam about an axis of the actuator in a first direction from a down position to an up position thereby extending each drive shaft upwardly, and each actuator operably rotates each cam about the axis of the actuator in a second direction opposite to the first direction to the down position thereby retracting each drive shaft downwardly. A disadvantage of this proposed invention is that when a user while reading braille on the display, as they move their finger around the reading surface may restrict any pin in motion from being raised or lowered by the system with their fingers. A pin therefore which failed to be raised or lowered, there is no way for the system to know about it and therefore would display incorrect combination of raised pin resulting in erroneous reading. Moreover, for a braille display of let say 20 characters build with the above method, it would require about 160 actuators each rotating the cam and raising the corresponding pin, creating an audibly loud noise. Blind users often find it uncomfortable using such a device in silent environments like Library, School or the office.

US20190304340A1 discloses a braille display cell and associated braille pin support and pin actuation assemblies. The braille display cell can include a frame, braille pins movable up and down between raised and lowered positions, and a pin actuation assembly to individually move the pins. The braille display cell can include support arms, each of which having a base end connected to the frame and a pin end connected to and following a motion of a respective pin between its raised and lowered positions. The pin actuation assembly can include pin actuation units, each having a motor with a rotatable motor shaft and multiple cams mounted on the shaft, each for selectively actuating a respective pin. Each pin actuation unit can also include an angular position sensing system for monitoring, for example magnetically, a passage of the shaft through a reference angular position, and deriving information about a current angular position of the shaft. The motor used in the above system is a micro-stepper motor which requires precise rotational position control and a complex drive. Moreover, a single micro-stepper motor is driving two cams which further raise two pins which would mean that to achieve a particular combination among the four possible combinations of the two pins, the motor will need to rotate the cams through all the intermediary combinations of raised pins going from the current combination. A user therefore could feel all the intermediary dot combinations as well before the final combination is displayed resulting in unnecessary tactile noise causing confusion to the reader. Having to go through the intermediary combination makes the refresh rate of the system very slow and the given complexity of having to precisely control the rotation of the micro stepper motor can make the system unreliable.

Therefore, the state of art refreshable braille display device runs into a common problem of random dots that stop working. It is often difficult for a user who is not so proficient in Braille to identify that a particular dot has stopped working as they might continue to read the wrong combination of dots in the given cell. Refreshable braille display devices need frequent maintenance and repair resulting in downtime where the user is not able to use. Downtime is especially detrimental when the devices are used in educational settings hampering the education of the student.

Furthermore, the conventional tools used for braille writing by the blind includes a braille slate and a stylus which allows them to write which is by embossing dots on a paper. The slate is made up of two pieces of metal or plastic connected by a hinge. When the hinge is closed, one-piece rests on top of the other. The top piece consists of rows of rectangles. Each rectangle overlays a grid with six indented dots. To write using a braille slate, a piece of paper is placed between the two layers. The user then uses the stylus to create indentations within each rectangle. The braille stylus has a wooden or plastic handle and a sharp metal point. The metal point is what embosses the paper to create the raised dots. The method of writing using slate and stylus has many limitations including having to remember the mirror image of every braille character as the dots are embossed on the back side of the paper, and having to remove the paper out each time the user has to read what they have embossed or to correct any mistake.

Accordingly, there is therefore a need for a refreshable braille display cell system which is easy to assemble, cost effective, has a high refresh rate, is reliable in a way that allows the user to read and run their fingers across the display even when the display is refreshing by incorporating a feedback mechanism and that which allows user to enter braille via writing as well.

### OBJECTS OF THE INVENTION

A general object of the present invention is to provide a Braille display cell system with simple construction

Yet another object of the present invention is to provide a Braille display cell system with high refresh rate and low energy consumption.

Still another object of the present invention is to provide a Braille display cell system which is easy to assemble and repair.

Another objective of the present invention is to provide a Braille display cell system which can be used for both reading and writing purpose.

Another objective of the present invention is to provide a Braille display cell system with digital feedback mechanism.

### SUMMARY OF THE INVENTION

The summary is provided to introduce aspects related to a Braille display cell system device for assisting visually impaired people or sighted people to learn or understand and read Braille. Further aspects of the Braille display cell system are described below in the detailed description. This summary is not intended to identify essential features of the claimed subject matter nor is it intended for use in determining or limiting the scope of the claimed subject matter.

The proposed invention discloses a braille display cell that can facilitate construction of single line braille display systems. The braille display cell system is constructed out of Cell case, Cell cap, a printed circuit board, plurality of braille pins, plurality of rotary actuator, each paired with a composite Cam.

A cell case is the main structural component of the braille display cell which comprises of housing for rotary actuators, guideways for braille pins, a window or mounting arrangement for proximity sensor, reading surface containing 6 or 8 holes wherein each hole allows a braille pin to move up and down forming Braille characters. The reading surface is orthogonal to the guideways provided for braille pins and is therefore orthogonal to the direction of motion of the braille pins. The guideways are long rectangular ribs that ensure smooth guided linear motion of the braille pins. Rotary actuator housings are provided on opposite sides below the reading surface such that each housing is off-set towards the centre by a small distance with respect to the housing above it. The housing is designed such that a cylindrical rotary actuator for example a small DC motor can be press fitted into the housing. The cell case on its main structural wall which is orthogonal to the reading surface has a plurality of windows for the proximity sensor. Additionally, the front inner surface has another set of windows or rectangular holes each placed close to the corresponding window for proximity sensor. Each of these 6 windows have an arrangement for mounting a L-shaped side lever.

A rotary Actuator is a micro DC motor capable of rotating a shaft in both directions. The actuator can have electrical contacts or wire leads through which a DC voltage can be supplied which results in rotation of the shaft. The direction of rotation of the shaft is determined by the direction or polarity of voltage applied across the electrical contacts or leads.

A Composite cam is coupled to the shaft of the rotary actuator. The composite cam contains two elements. The first element is a profiled curved surface around the axis forming the face of the cam, which can cause a follower in contact to move linearly in a plane orthogonal to the axis of the cam, as the cam rotates. The profile of the cam is designed such that when it is rotated in one direction by a defined angle it causes the braille pin to move upward or away from the axis of the cam and when rotated in the opposite direction by a defined angle, the follower moves closer to the axis. The second element is an offset extrusion extending radially outward in a plane orthogonal to the axis of the cam. The second element of the cam interacts with the proximity sensor in a way that the proximity sensor can detect the rotational position of the cam. Both elements of the cam are fused such that they are radially opposite to each other thereby ensuring the cam is rotationally balanced.

Braille pins are pairs of 3 or 4 distinctive pins which on one end has planar surface called foot of the braille pin extruding orthogonal to the length of the braille pin which interacts with the curved profile face element of the cam acting as followers and a further extrusion down along the length of the braille pin below its foot. The other end of the braille pin has a cylindrical shape ending in a dome making the braille pin act as tactile pins forming the dots of Braille extending upward from the reading surface upon being raised. Each of these braille pins contain a long rectangular body in the middle section. The braille pins are placed between the guideways provided on the cell case such that the face of the braille pin and guideways are parallel. The cylindrical elements on upper end of the braille pins are aligned coaxially in the holes on the reading surface such that when the braille pin is raised by the rotation of the corresponding cam, the tactile tip i.e. the domed end of the braille pin extends upward from the reading surface which the user can touch to read braille.

A ‘L’ shaped side lever is mounted to the cell case and pivoted by the centre of the two arms of the lever such that one arm is horizontal or orthogonal to the direction of motion of the braille pins, and the other arm is vertical i.e. parallel to the direction of the motion of the braille pins. The braille pins when in a recessed position the extruded element of the braille pin below its foot rests on the Horizontal arm of the lever. The vertical arm of the lever is designed to be in contact with the switch mounted on a printed circuit board through the window provided in the cell case.

The printed circuit board is mounted behind the cell case. The printed circuit board has necessary electrical contact pads and electrical circuitry required to controllably power the rotary actuators and further has proximity sensors mounted on it or electrically connected to it. The printed circuit board is aligned behind the cell case such that the electrical pads on the board align with the electrical contacts on the rotary actuators. The printed circuit board further has provisions for it to be connected to an external microcontroller which can both controllably drive the circuit needed to power the rotary actuators and also read the signals from the proximity sensors to detect the rotational position of the cam.

A proximity sensor is provided which interacts with the offset radial extrusion element of the composite cam such that a varying electrical signal is generated from the proximity sensor based on the rotational position of the cam.

A switch is provided that interacts with the extruded element of the braille pin below its foot either directly or via the L-shaped side lever such that the braille pin in recessed position when further pushed in by the user using a braille stylus, presses and actuates the switch.

A Cell cap once fastened to the cell case makes the cell a closed assembly. The cell cap is fastened once the cell case is assembled in with all rotary actuators each coupled with a composite cam and the corresponding braille pin resting on the cam. The cap ensures mechanical integrity of the entire assembly as well as holds the printed circuit board with the cell case.

Other aspects and advantages of the invention will become apparent from the following description, taken in conjunction with the accompanying drawings, illustrating by way of example the principles of the invention.

### BRIEF DESCRIPTION OF THE DRAWINGS

The accompanying drawings constitute a part of the description and are used to provide further understanding of the present invention. The drawings illustrate exemplary embodiments of the present disclosure and, together with the description, serve to explain the principles of the present disclosure.

FIG. 1A illustrates a cell case and FIG. 1B illustrates a ‘L’ shaped side lever and FIG. 1C shows a arrangement of the ‘L’ shaped side lever in the cell case. ;

FIG. 2A illustrates a perspective view of a composite cam and FIG. 2B illustrates arrangement of the composite cam on a rotary actuator;

FIG. 3A illustrates a perspective view of a braille pins, and FIG. 3B illustrates position of the braille pin with the cell case;

FIG. 4A illustrates an exploded view and FIG. 4B illustrates the assembled view of a refreshable braille display cell system;

FIGS. 5A and 5B illustrates a first and FIGS. 5C and 5D illustrate a second positional configuration of the braille pin and a composite cam during operation and the optical diagram of the emitted infrared light;

FIG. 6A and FIG. 6B illustrates position of the braille pin during operation using a stylus;

FIG. 7A illustrates an embodiment of the refreshable braille display cell system and FIG. 7B illustrates an embodiment of the composite cam and FIG. 7C illustrates a smaller printed circuit board. ;

FIGS. 8A and 8B illustrate a first and FIGS. 8C and 8D illustrate a second positional configuration of the braille pin and the composite cam during operation and the optical diagram of the emitted infrared light.

### DETAILED DESCRIPTION OF THE INVENTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

If the specification states a component or feature “may”, “can”, “could”, or “might” be included or have a characteristic, that particular component or feature is not required to be included or have the characteristic.

The present invention relates to a Braille display cell system for visually impaired people. The Braille display cell system is build using a stack of braille display cells each comprising of a cell case, a plurality of L-shaped levers, braille pins, rotary actuators, composite cams, printed circuit board, proximity sensors, switches mounted to the printed circuit board and a cell cap.

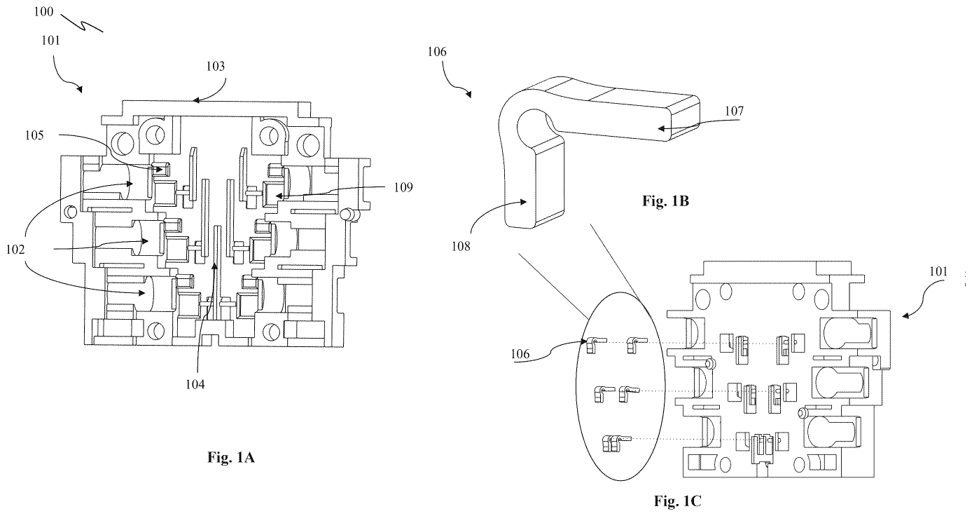

FIG. 1A illustrates a cell case and FIG. 1B illustrates a ‘L’ shaped side lever and FIG. 1C shows a arrangement of the ‘L’ shaped side lever in the cell case. A cell case 101 is main structural part of the braille display cell system and shaped like an open rectangular box. On the inner side of the rectangular box shape of the cell case 101, 6 housings 102 for rotary actuators are integrated with 3 on the left and 3 on the right side. The rotary actuator housing 102 is designed in shape of a half cylinder for the inner half along its length and an opposing half square shaped enclosure for the outer half of the length. It is further designed such that a small rotary actuator can be press fitted from behind into the housing 102. Each rotary actuator housing 102 on both sides is placed offset inwards towards the centre compared to the housing placed on top of it.

The outer surface on the top side of the cell case 101 consists of 6 holes each corresponding to a dot in a 6-dot braille display cell, thereby forming the reading surface 103 not visible in FIG. 1A. The front inner surface of the cell case 101 forms the main structural wall of the cell. At the centre of the front inner surface of the cell case 101 between the rotary actuator housings are guideways 104 provided f. These guides are thin rectangular ribs that run perpendicular to the reading surface. The front inner surface additionally has 6 rectangular extrusions perpendicular to the surface called restrictors 105. The front inner surface also has 6 windows 109 or rectangular holes each placed near the rotary actuator housing Additionally, the front inner surface has another set of 6 windows or rectangular holes each placed close to the corresponding window for proximity sensor. Each of these 6 windows have an arrangement for mounting and pivoting a L-shaped side lever 106. The back side outer surface of the cell case has pips or cylindrical extrusion that help the printer circuit board to be aligned rightly with the cell case.

A ‘L’ shaped side lever 106 is mounted to the cell case 101 and pivoted by the centre of the ‘L’ arms of the lever such that one arm is horizontal 107 direction of motion of the braille pins, and the other arm is vertical 108 as shown in FIG. 1B. 6 L-shaped side levers snapped to their respective mounting arrangements on the cell case from behind as shown in FIG. 1C.

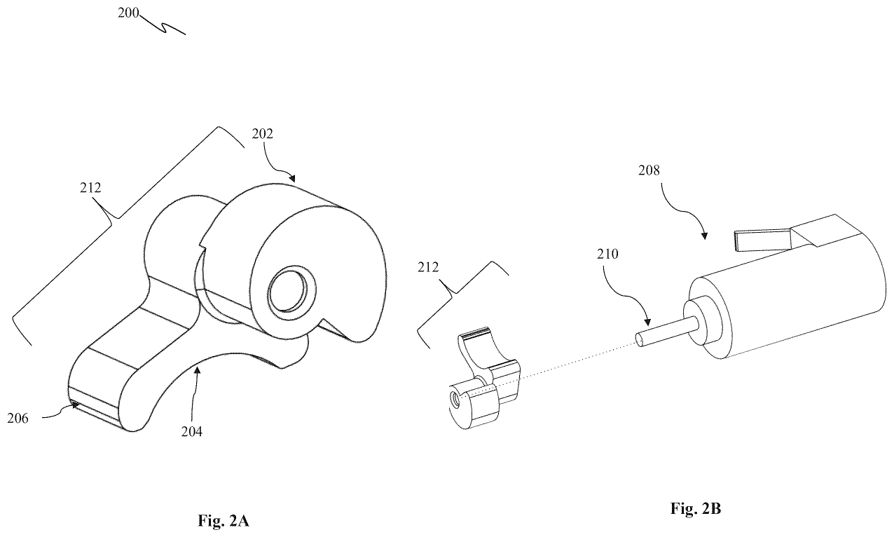

FIG. 2A illustrates a perspective view of a composite cam 212 and FIG. 2B illustrates arrangement of the composite cam on a rotary actuator 208. The rotary actuator 208 is a small cylindrical DC motor capable of rotating the shaft 210 in both clockwise and counter clockwise directions. The rotary actuator 208 has contact leaf springs as input terminals on the side, across which a DC voltage is applied that results in rotation of the shaft 210 corresponding to the polarity of the applied voltage.

The rotary actuators 208 are press fitted in each of the 6-housing 102 provided in the cell case 101 terminals on the rotary actuator 208. In another embodiment, the rotary actuator 208 has a pair of insulated wires as input terminals instead of contact leaf spring, through which a DC voltage can be applied to cause rotation of the shaft 210.

A Composite cam 212 is coupled to the shaft 210 of each of the 6 rotary actuators 208. The composite cam 212 contains two elements. The first element is a curved profile surface 202 around the axis forming the face of the cam, which can cause a follower in contact to move linearly in a plane orthogonal to the axis of the cam, as the cam rotates. The profile of the cam is designed such that when it is rotated in one direction by a defined angle it causes the follower to move upward or away from the axis of the cam and when rotated in the opposite direction by a defined angle, the follower moves closer to the axis. The second element is an offset extrusion 206 extending radially outward in a plane orthogonal to the axis of the cam. The second element of the cam has a flat face on one side and a concave face 204 on the other. Both the elements of the cam are fused such that they are radially opposite to each other thereby ensuring the cam is rotationally balanced.

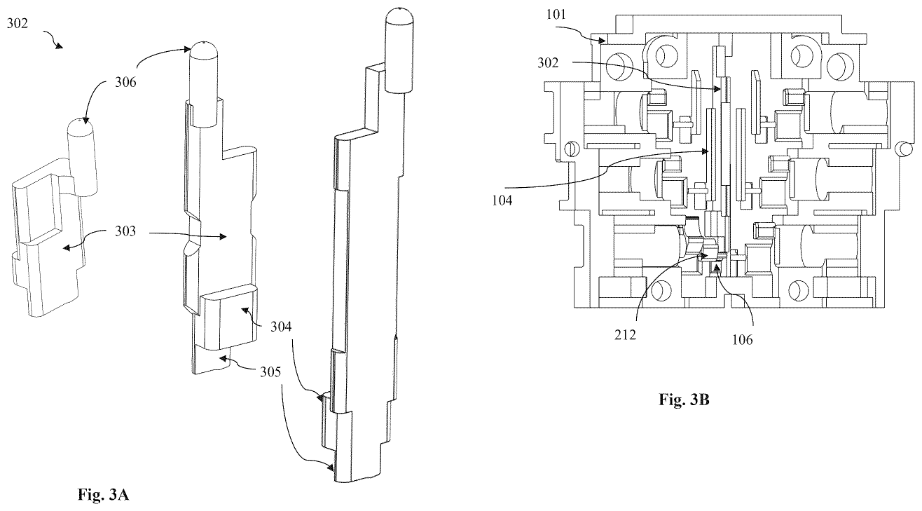

FIG. 3A illustrates a perspective view of braille pins, and FIG. 3B illustrates position of the braille pin with the cell case 101. Three pairs of distinctive braille pins 302 of varying lengths are used in the braille display cell system as shown in FIG. 3A. Each braille pin 302 has a long rectangular body 303 in the middle, further on one end has a planar face called foot 304 of the braille pin 302 extruding orthogonal to the length of the braille pin 302. The planar face on the foot 304 interacts with the profiled surface of the composite cam 212 acting as followers. Further on the braille pin 302 below its foot, there's a extrusion 305 down along the length of the braille pin 302 which interacts with the L-shaped side lever 106 mounted on the cell case 101. The pins are placed between the guideways 104 provided on the cell case 101 such that the long rectangular body 303 of the braille pin 302 and guideways 104 are parallel as shown in FIG. 3B. The upper element of the braille pins is a cylinder with a domed end forming the tactile tip or dots 306 of the braille. The cylindrical elements on the pin are aligned coaxially in the corresponding holes on the reading surface 103.

FIG. 3B illustrates position of the braille pin 302 with the cell case 101. More specifically FIG. 3B refers to the braille pin 302 in recessed position resting on the L-shaped side lever 106 and floating over the curved profile surface 202 of the composite cam 212. Each of the three distinct braille pins 302 resting on the L-shaped side lever 106 interacting with a composite cam 212 coupled to a rotary actuator 208 placed on the left side, can be laterally inverted and placed resting on the composite cam 212 coupled to the corresponding rotary actuator 208 on the right side.

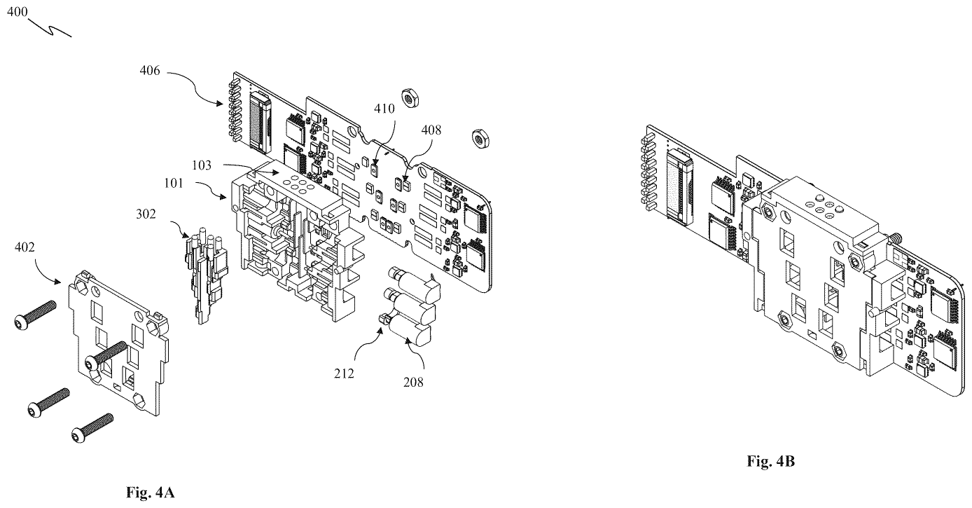

FIG. 4A illustrates an exploded view and FIG. 4B illustrates the assembled view of a braille display cell system 400. A printed circuit board 406 is fastened behind the cell case 101 has 6 pairs of electrical contacts/pads that align with the contact leaf spring input terminals on each of the rotary actuators 208. The printed circuit board 406 further has the electrical circuitry required to controllably power the rotary actuators 208. The printed circuit board 406 further has 6 proximity sensors 408 mounted on it, each corresponding to a composite cam 212 coupled to a rotary actuator 208. The proximity sensor employed here is an optical Infrared emitter receiver pair which generates an output electrical voltage proportional to the intensity of the reflected infrared light incident on the receiver. Adjacent to each of the 6 proximity sensors, are switches 410 mounted which interact with the L-shaped side lever 106 part on the cell case 101. The printed circuit board 406 further has provisions for it to be connected to an external microcontroller 420 (not indicated in the figure) which can both controllably drive the circuit needed to power the rotary actuators 208 and also read the electrical voltage from the proximity sensors 408 and signals from the switch 410. In another embodiment, the printed circuit board 406 can have components i.e. electrical contacts, proximity sensors and switches mounted on both side of the board such that a set of cell case 110, rotary actuators 208, braille pins 302 and cell cap can be fastened on the other side as well forming a twin cell assembly.

The cell cap 402 is a part that sits like a lid on the rectangular open box shaped cell case 101 part. The cell cap 402 and the cell case 101 have pins and corresponding mating hole so that they can be press fitted into each other via an interference fit forming a closed rectangular box. The cell cap has 6 windows at the same projected position from the corresponding window for the proximity sensor on the cell case.

As previously mentioned, FIG. 4A illustrates an exploded view of the entire braille display cell assembly 400. The cell case 101 held vertically with the 6 composite cam 212 coupled rotary actuator 208 press fitted in their housing 3 each on the left and the right side along with each of the 6 L-shaped side levers 106 pivoted on their respective mounting points close to each of the rotary actuator 208 housings. 3 braille pins are placed in their recessed position resting on the horizontal arm 107 of their respective L-shaped side lever 106 and their feet 304 floating to their respective composite cam 212 on the left side, and with their tactile tip 306 coaxially aligned with the respective hole on the reading surface 103 of the cell case 101. Identical to each of the 3 braille pins 302 on the left, 3 additional pins are placed laterally inverted resting on the horizontal arm 107 of their respective L-shaped side lever 106 and their feet 304 floating to their respective composite cam 212 on the right side further such that their tactile tip 306 are coaxially aligned with the respective hole on the reading surface 103 of the cell case 101. The printed circuit board 406 is placed at the back side of the cell case 101 with the contact leaf spring input terminals of the rotary actuators 208 aligned to their respective electrical contact pads on the printed circuit board 406. The cell cap 402 is further placed on the front side of the cell case 101 and is fastened using fasteners to the cell case 101 along with the printed circuit board 406 closing the entire assembly. The electrical connector provided on the printed circuit board 406 allows it to be configured and controlled by the external microcontroller 420.

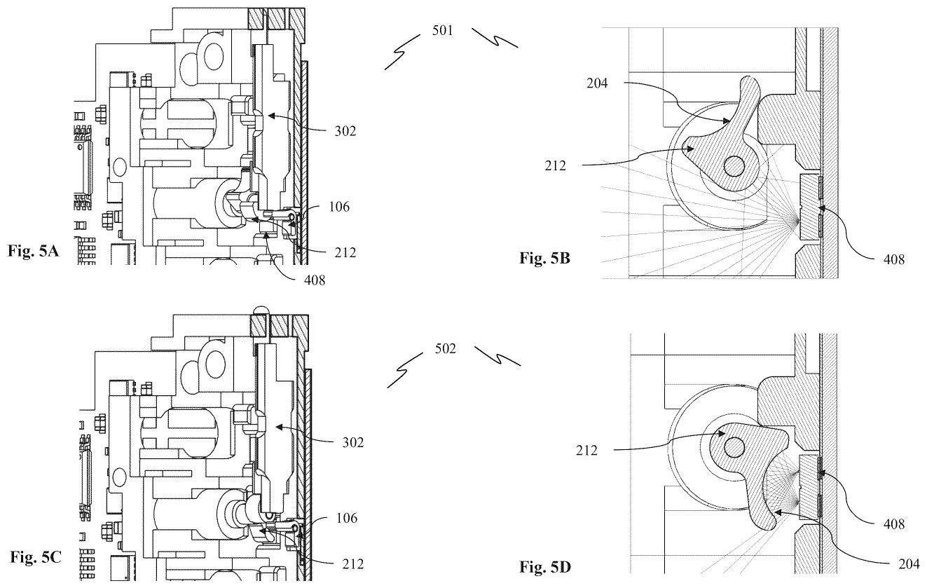

FIGS. 5A and 5B illustrates a first 501 and FIGS. 5C and 5D illustrate a second 502 positional configuration of the braille pin and a composite cam 212 during operation and the optical diagram of the emitted infrared light. Starting from a first positional configuration 501, wherein the braille pin 302 is recessed below the reading surface 103 and resting on the horizontal arm 107 of the L-shaped lever 106 and the foot 304 floating over the composite cam 212. The composite cam 212 is in an angular position such that the offset radial extrusion element 206 of the composite cam 212 faces up towards the reading surface 103 and is in contact with the restrictor 105 by residing over it. The electrical circuit on the printed circuit board 406 upon receiving inputs from the external microcontroller 420, applies an appropriate voltage across the contact leaf spring input terminals of the rotary actuator 208. The polarity of these voltages is such that the shafts and therefore the composite cam 212 on the three rotary actuators 208 on the left rotate counterclockwise. As the composite cam 212 rotates, its curved profiled face 202 comes in contact with the foot 304 of the braille pin 302 and with further rotation of the composite cam 212 the curved profile face element 202 raises the braille pin 302 up such that the domed tactile tip 306 is raised above the reading surface 103 to an appropriate height which a user can read by touch.

The fact that the foot 304 of the braille pin is floating above the curved profile face 202 element of the composite cam 212, the composite cam 212 rotates freely by certain angle during the start which therefore eliminates excessive starting torque load on the rotary actuator 208. Micro DC motors employed as rotary actuators here have inherently low operating torque output on their shaft. The external load of lifting a braille pin 302 being eliminated during the start position and being gradually induced as the composite cam 212 comes in contact with the foot of the braille pin 302, ensures smooth torque application on the rotary actuator. This greatly reduces failure because of insufficient starting torque by the rotary actuator and increases the overall reliability of the braille display cell.

The composite cam 212 rotates up to an angle till the offset radial extrusion element 206 on the cam impacts the restrictor 105. The voltage applied across the contact leaf spring input terminals of the motor is removed at this point and the composite cam 212 and the braille pin 302 achieves the second positional configuration 502 as indicated in FIG. 5C.

FIG. 5D illustrates a detailed section view of the second positional configuration 502 along with the ray diagram of the emitted infrared light from the proximity sensor. 408. Once in this rotational position, the curved concave face 204 the composite cam 212 faces the window 109 and thereby the proximity sensor 408 mounted on the printed circuit board 406. The infrared emitter in the proximity sensor 408 is powered at this instance wherein the emitted infrared light falls incident on the curved concave surface 204 and is reflected back. The curvature of the concave surface 204 is designed such that a majority of the incident infrared light is reflected back and focused towards the receiver on the proximity sensor 408 as evident with the ray diagram in the FIG. 5D. The proximity sensor 408 outputs an analogue voltage which is proportional to the intensity of the incident infrared light. The analogue voltage value is read by the electrical circuit on the printed circuit board 406 which can be further communicated to the microcontroller 420.

To lower a raised braille pin, a voltage of reverse polarity is applied across the contact leaf spring input terminals of the rotary actuator. The composite cam 212 now rotates in clockwise direction through an angle until the offset radial extrusion element 206 on the cam impacts the restrictor 105 and resides over it. The composite cam 212 and the braille pin return to the first configurational position 501 as shown in FIG. 5A. FIG. 5B illustrates a detailed section view of the first positional configuration 501 along with the ray diagram of the emitted infrared light from the proximity sensor. 408. The offset radial extrusion element 206 is again facing upwards and the domed tactile tip 306 of the braille pin is recessed back below the reading surface 103. In this position, the offset radial extrusion element 206 is not in the path of the infrared light emitted from the emitter on the proximity sensor 408. In the first positional configuration 501, the fraction of emitted infrared light that is reflected by the composite cam 212 and is incident on the receiver, is very low compared to that in the second positional configuration 502 as evident from FIG. 5B.

The proposed design configuration results in output of two far spaced analogue voltage values from the proximity sensor, wherein each value is within a narrow tolerance range. In an embodiment a voltage comparator circuit converts signals analogue to digital. A voltage comparator circuit using an operational amplifier can be implemented with a threshold reference voltage value placed between the two voltage values above, such that the voltage comparator circuit further outputs two discrete voltage value which are within the digital voltage ranges for ‘High’ and ‘Low’ levels. The proposed design outputs digital voltage values for each dot of the braille display cell indicating whether it is raised or recessed by detecting the two stop positions of the composite cams 212. This eliminates the need for any complex circuitry having to read a large number of analogue channels. The braille display cell therefore operates in a closed loop system at the dot level with digital feedback for each dot based on which corrective signals can be generated.

Before any actuation i.e. application of voltage in either polarity to the contact leaf spring input terminals of the rotary actuator 208, the microcontroller 420 sends signal to the proximity sensor 408 to read the binary state of the dot (raised or recessed) by reading the position of composite cam 212. The Infrared emitter on the proximity sensor is turned ON by sending a signal from the microcontroller 420. The emitted infrared light is incident on the composite cam 212 and a portion of it is reflected back towards the receiver of the proximity sensor 408. The proximity sensor 408 outputs an analogue voltage value which if it is above a threshold voltage value, the voltage comparator circuits output a digital ‘High’ value and if below the threshold, outputs a digital ‘Low’ value. The output digital value is read by the microcontroller 420 to understand the position of the composite cam 212 and the braille pin 302 and thereby the state of the dot whether it is raised or recessed. In the proposed invention, when the braille pin 302 is in the second positional configuration 502 i.e. raised as shown in FIGS. 5C and 5D, the offset radial extrusion element 206 on the composite cam 212 faces downward away from the reading surface 103 such that the curved concave face 204 of the composite cam 212 faces the proximity sensor 408 further such that most of the infrared light emitted from the proximity sensor 408 is incident on the concave face and a high portion of this incident light is reflected back towards the receiver on the proximity sensor 408. The proximity sensor 408 outputs a high analogue voltage value which is further outputted as a digital ‘high’ value from the voltage comparator circuit, which is further read by the microcontroller 420. A digital ‘high’ value therefore read by the microcontroller 420 outputted by the proximity sensor 408 indicates that the braille pin and therefore the braille dot is raised. Once the digital value is read by the microcontroller 420, the infrared LED emitter on the proximity sensor 408 is turned OFF again.

In the same manner when the braille pin 302 is in the first positional configuration 501 and therefore the braille dot is recessed shown in FIGS. 5A and 5B, the offset radial extrusion element 206 of the composite cam 212 faces upwards i.e. towards the reading surface 106 and is also away from the proximity sensor 408. When the microcontroller 420 sends the signal to turn ON the infrared emitter on the proximity sensor 408, a very small portion of the emitted light is incident on the composite cam and is reflected back towards the receiver. The offset radial extrusion element 206 being away from the proximity sensor 408, there is practically nothing in the field of view of the emitter and therefore only a small portion of the emitted light is incident on the composite cam 212 and a further smaller portion of that light is reflected back towards the receiver of the proximity sensor 408. The proximity sensor 408 outputs a low analogue voltage value which is further outputted as a digital ‘low’ from the voltage comparator circuit which is further read by the microcontroller 420. A digital ‘low’ value therefore read by the microcontroller 420 outputted by the proximity sensor 408 indicates that the braille pin 302 and therefore the braille dot is recessed.

The microcontroller 420 connected to the refreshable braille display cell 400 for each dot before actuation i.e. raising or lowering it, reads the digital signal generated from the corresponding proximity sensor 408. The microcontroller 420 checks whether this value corresponds to the last ideal state of that dot which was stored in the memory. For example, if the last character display on the braille display cell required the said dot to be raised, the microcontroller 420 checks whether the dot is indeed in a raised state by checking if the proximity sensor 408 outputs a digital ‘High’ value. If the value of the last ideal state of the dot stored in the memory matches with that read from the proximity sensor 408, the microcontroller 420 proceeds to figuring out the next desired state of the dot. If the dot is to be recessed, the microcontroller 420 sends signals to the actuator driver which applies voltage across the contact leaf spring input terminals of the rotary actuator 208 to rotate the composite cam 212 in a direction that lowers the braille pin 302. The voltage is applied only for a short duration which is generally in the order of millisecond which is enough for the composite cam 212 to rotate from the first positional configuration 501 to the second 502 or otherwise. Once the braille pin 302 is lowered, the microcontroller 420 checks if the proximity sensor outputs a digital ‘Low’ which validates that the dot has actually been lowered. Any deviation from the desired state of the dot, is read by the microcontroller 420 and corrective signals are sent by the microcontroller 420 to ensure that the dot achieves the desired state.

In the proposed refreshable braille display cell 400, the electromechanical operation of a dot is a closed loop system that gives digital feedback to the microcontroller 420 and further the microcontroller 420 sends corrective signals to achieve the desired state of the dot. Braille dots on refreshable braille display cells are often prone to failure. Dots may fail to rise or lower simply because while reading the user's fingers may have obstructed their motion. Dots that therefore failed to rise or lower because of the user's fingers are detected by the microcontroller 420 and can be raised or lowered the instant the user moves their fingers away. This allows the display to work seamlessly even when the user is continuously moving their fingers over the display while reading.

Braille slate and stylus are conventional tools used by the blind to write braille by the means of embossing or punching dots the back side of a paper. The proposed refreshable braille display cell 400 can further function as a braille writing apparatus as well where it can electrically read the input given by the user by means of embossing or punching the dots down using a stylus.

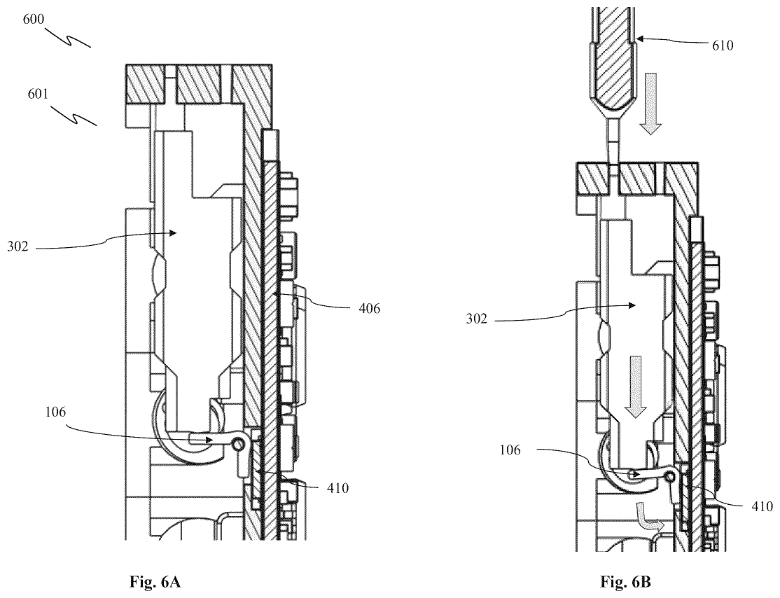

FIG. 6A illustrates a section view showing the braille pin 302 in the first positional configuration 601 i.e. in the recessed position with the braille pin 302 resting on the horizontal arm 107 of the L shaped side lever 106. Writing is achieved by the user by means of pushing down the braille pin using a stylus 610. FIG. 6B illustrates position of the braille pin during operation using a stylus 610. The braille pin 302 resting on the horizontal arm 107 of the L-shaped side lever 106 when pushed down by the user using a stylus cause the L-shaped side lever 106 to rotate by its pivot further such that the vertical arm 108 of the L-shaped side lever to actuate the switch 410 mounted on the printed circuit board 406. The actuation or pressing of the switch 410 creates an electrical signal which can be read by an external microcontroller 420 to identify the dot embossed by the user. Once the user removes the stylus 610, the spring action of the switch 410 causes the L-shaped side lever 106 to rotate back and brings the braille pin 302 to its original receded position as shown in FIG. 6A. The switch 410 employed for this application can be a small tactile switch which on pressing by the L-side shaped side lever 106 gives a tactile feedback which is mechanically relayed via the braille pin 302 and stylus 610 to the user, thereby via tactile means indicating to the user that an input has been registered. In another embodiment of the invention, the switch 410 could be a dome switch or an elastic membrane switch or any contact based mechanical input methods.

In an embodiment, the braille display device is constructed using 40 or 20 of the proposed refreshable braille display cells 400. The proposed braille display cell in single or twin cell configuration can be stacked next to each other forming a single line braille display of any integer character length. The braille display cell facilitates a closed loop system for every dot in every cell and further the configuration allows for a closed loop system where the feedback is read via a single digital voltage value for each dot. This enables easy reading of feedback signals from a large number of dots present in a 20 or 40 cell braille display by simply reading a single bit digital value corresponding to each dot in the display and therefore eliminates the need for complex and expensive circuits needed to read a large number of analogue voltage channels. This greatly reduces the computational strain on the microcontroller 420 allowing a refreshable braille display device to be built using a low end/entry level microcontroller 420.

Refreshable braille display system built using the proposed braille display cell with digital feedback based closed loop system at dot level allows for a faster refresh rate and low power consumption. A 20-cell refreshable braille display device going from one display state to another can leverage the feedback received to be certain about the current display state and selectively operate only those dots which have different states between the two display states across the 20 cells. This greatly reduces the number of the dots which need to be operated and thereby reducing the power requirement going from one display state to another. If a lesser number of dots are to be operated, a greater number of braille display cells can be operated at the same instance when draining power from a constrained electrical source like a battery. This greatly increases the refresh speed.

In an embodiment, the braille display cell system refers to 8-dot refreshable braille display cell configuration. The proposed braille display cell design above can also be expanded to a 8 dot braille display cell which employs a cell case that houses 8 rotary actuators and the reading surface having 8 holes, 8 L-shaped side lever mounted to the cell case, 4 pairs of braille pins, and a printed circuit board that houses 8 proximity sensors and switches. The 8 dot configuration can also be implemented by having cell case assemblies on both sides of the printed circuit board forming a twin 8-dot braille display.

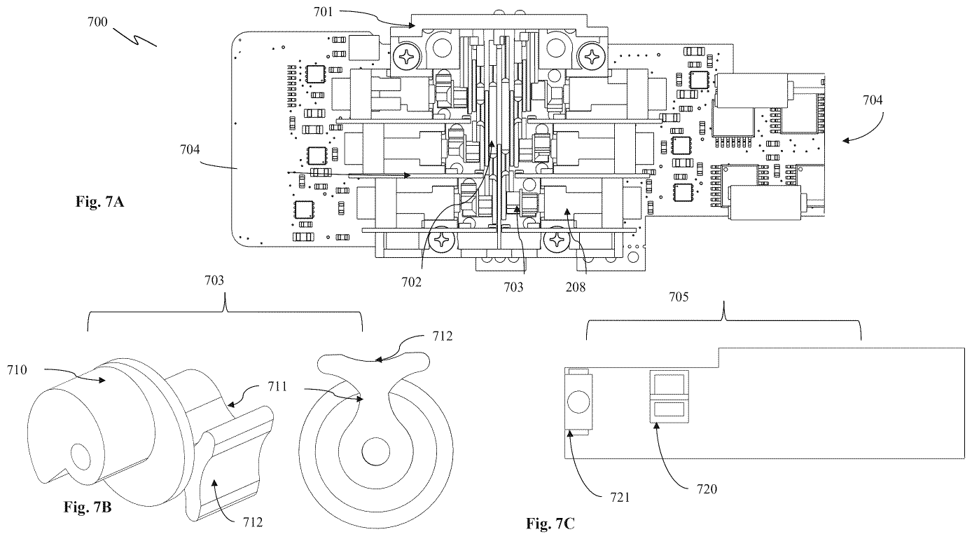

In an implementation, a variation in the design of the composite cam and the position of the proximity sensor and the switch is proposed. FIG. 7A illustrates a 6 dot Braille display cell assembly 700 constructed with a cell case 701, 3 pairs of braille pins 702, 6 rotary actuators 208 each coupled with a composite cam 703, a printed circuit board 704 and a set of 6 additional smaller printed circuit boards 705. The cell case 701 used is identical to the cell case 101 disclosed above in most aspects except for few variations. Provisions are given to mount small printed circuit boards 705 below each rotary actuator housing both on the right and left side. The windows provided for the proximity sensors in the front inner face on the cell case design disclosed earlier are eliminated. Instead of using a single extrusion as a restrictor to the composite cam 703, a pair of extrusions functioning as restrictors 730 are placed on either side of the shaft of the rotary actuator on the front inner face of the cell case 701. These pair of extrusions help restrict the rotational motion of the corresponding composite cam 703 in either direction allowing it to come to rest at a defined angular position each corresponding to a raised and recessed state of the braille pin 702. The design of the rotary actuators 208 is the same as that disclosed previously.

FIG. 7B illustrates an embodiment of the composite cam 703. More specifically, the composite cam 703 employs a curved profile surface 710 to lift the braille pin. The second element of the composite cam 703 which is the face that interacts with the proximity sensor involves a ‘T’ shaped extrusion 711 as indicated in the FIG. 7B. The T shaped extrusion 711 is placed radially opposite to the offset of the profile of the composite cam such that the composite cam 703 is rotationally balanced. The outer face of the T shaped extrusion 711 on the composite cam 703 has a concave shape 712. The printed circuit board (not shown) fastened to the back of the cell case has the same design features as previously disclosed with the exception that the proximity sensors and switches (not shown) are mounted elsewhere.

FIG. 7C illustrates a set of 6 additional smaller printed circuit boards 705 are included in the design with each of them having a proximity sensor 720 and a switch mounted 721 on them. These smaller printed circuit boards 705 are fitted in the cell case 701 below the rotary actuator housing, 3 on the left and 3 on the right such that all of them are orthogonal to the printed circuit board fastened 704 behind the cell case. These smaller printed circuit boards 705 extend outwards outside the cell case and are further electrically connected to the printed circuit board 704 placed behind the cell case either through wires or directly soldering edge solder pads on both the printed circuit boards. The proximity sensors mounted 720 on the smaller printed circuit boards here are Infrared emitter-receiver pairs which generate an electrical voltage proportional to the intensity of the reflected infrared light incident on the receiver.

In an embodiment, the braille pins 702 are arranged in their recessed position resting on the switch 721 mounted on the small printed circuit board 705 and with their foot floating over the composite cam 703. The lengths of the various elements of the braille pin 702 are designed such that when braille the pin is in recessed position it is resting on the switch 721 and its foot is floating over the curved surface 710 of the composite cam 703 by a small distance.

In an embodiment, the cell case 701 held vertically with the 6 composite cam 703 coupled rotary actuator 208 press fitted in their housing 3 each on the left and right side. The 6 additional small printed circuit boards 705 each with the proximity sensor 720 and switch mounted 721 on it, is fitted below the rotary actuator housing on the cell case such that the proximity sensor 720 is aligned with the corresponding composite cam 703. 3 braille pins 702 are placed resting on their respective switch 721 and with their foot floating over their composite cam 703 on the left side, and with their cylindrical top element coaxially aligned with the respective hole on the reading surface of the cell case. Identical to each of the 3 braille pins on the left, 3 additional braille pins 702 are placed laterally inverted resting on their respective switch 721 and with their foot floating over their composite cam 703 on the right further such that their cylindrical top element are coaxially aligned with the respective hole on the reading surface of the cell case. The printed circuit board 704 is placed at the back side of the cell case with the contact leaf spring input terminals of the rotary actuators 208 aligned to their respective electrical contact pads on the printed circuit board 704 forming an assembly. A cell cap is further placed on the front side of the cell case and is fastened using fasteners to the cell case along with the printed circuit board closing the entire assembly. The electrical connector provided on the printed circuit board allows it to be configured to and controlled by an external microcontroller 420.

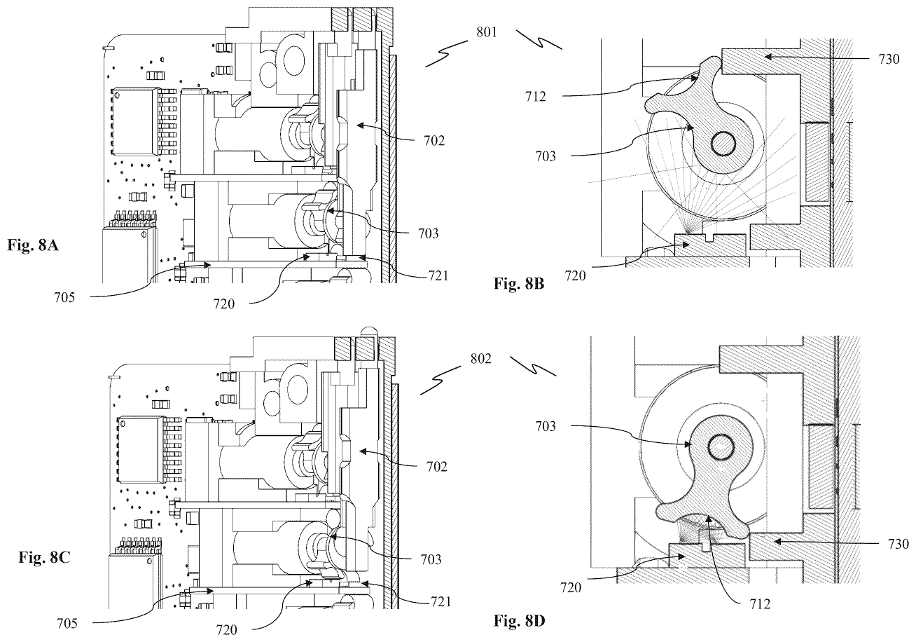

FIGS. 8A and 8B illustrate a first 801 and FIGS. 8C and 8D illustrate a second 802 of the braille pin 702 and the composite cam 703. Starting from first positional configuration 801 wherein the braille pin 702 is recessed below the reading surface and resting on the switch 721 with its foot floating over the curved profile face 710 of the composite cam 703. The composite cam 703 is in an angular position such that the outer concave face 712 of the T shaped extrusion element 711 of the composite cam 703 faces up towards the reading surface with the T shaped extrusion 711 being in contact with the restrictor 730 on the cell case placed above the shaft of the rotary actuator. The electrical circuit on the printed circuit board 704 upon receiving inputs from the external microcontroller 420, applies an appropriate voltage across the contact leaf spring input terminals of the rotary actuator 208. The polarity of these voltages is such that the shafts and therefore the composite cams 703 on the three rotary actuators 208 on the left rotate counter clockwise while those on the right rotate clockwise.

As the composite cam 703 rotates, its curved profiled face 710 comes in contact with the foot of the braille pin and with further rotation of the composite cam 703 the curved profile face 710 element raises the braille pin up such that the domed tactile tip of the pin is raised above the reading surface to an appropriate height which a user can read by touch. The fact that the foot of the braille pin 702 is floating above the curved profile face element 710 composite cam 703 rotates freely by a certain angle during the start which therefore eliminates any external starting torque load on the rotary actuator 208. The composite cam 703 rotates up to an angle till the side arm of the T shaped extrusion element on the cam impacts the restrictor 730 on the cell case placed below the shaft of the rotary actuator. The voltage applied across the contact leaf spring input terminals of the motor is removed at this point and the braille pin 702 and the composite cam 703 achieves the second positional configuration 802 as shown in FIGS. 7C and 7D.

FIG. 8B and FIG. 8D more specifically illustrates an optical diagram of infrared light and the composite cam. In the second positional configuration 802, the curved concave face 712 on the T shaped extrusion element 711 of the composite cam 703 faces the proximity sensor 721 4, mounted on the small printed circuit board 705 placed below the rotary actuator 208. The infrared emitter in the proximity sensor 721 is powered at this instance wherein the emitted infrared light falls incident on the curved concave surface 712 and is reflected back. The curvature of the concave surface is designed such that a majority of the incident infrared light is reflected back and focused towards the receiver on the proximity sensor 721 as shown in FIG. 7D.

The proximity sensor outputs an analogue voltage which is proportional to the intensity of the incident infrared light. The analogue voltage value is relayed to the printed circuit board 704 placed behind the cell case and is read by the electrical circuit on it which can be further communicated to the microcontroller 420. To lower a raised braille pin 702 i.e. the braille dot, a voltage of reverse polarity is applied across the contact leaf spring input terminals of the rotary actuator 208. The composite cam 703 now rotates in clockwise direction through an angle until the T shaped extrusion element 711 on the composite cam 703 impacts the restrictor 730 on the cell case 701 placed above the shaft of the rotary actuator 208. The composite cam 703 returns to the first rotational position, the T shaped extrusion element 711 is again facing upwards and the domed tactile tip of the braille pin 702 is recessed back below the reading surface and the braille pin 702 rests on the switch 721 and its foot is floating over the curved profile face 710 of the composite cam 703. In the first positional configuration 801, the fraction of emitted infrared light that is reflected by the composite cam 703 and is incident on the receiver of the proximity sensor 720, is very low compared to that in the second positional configuration 802.

As previously mentioned, FIG. 8B illustrates an optical diagram of the infrared light emitted out from the proximity sensor 720 and reflected back towards it. It is evident that in the first configurational position 801 a huge portion of the light is deflected away and only a small portion is reflected back towards the receiver on the proximity sensor 720. The proximity sensor therefore outputs a lower analogue voltage value in this position. The proposed design configuration results in output of two far spaced analogue voltage values from the proximity sensor, wherein each value is within a narrow tolerance range. In an embodiment a voltage comparator circuit using an operational amplifier is implemented with a threshold reference voltage value placed between the two voltage values above, such that the voltage comparator circuit further outputs two discrete voltage value which are within the digital voltage ranges for ‘High’ and ‘Low’ levels as discussed earlier in previous embodiment.

The proposed feature therefore outputs a single bit digital voltage value for each dot of braille display cell 700 indicating whether it is raised or recessed by detecting the two stop positions of the composite cams 703. This eliminates the need for any complex circuitry having to read a large number of analogue channels. The proposed braille display cell 700 can further function as a braille writing apparatus as well where it can electrically read the input given by the user by means of embossing or punching the dots down using a stylus.

In the braille display cell, when all the dots are in recessed position, the braille pins 702 are all resting on their respective switch and their foot is floating over the curved profile face 710 element of the composite cam 703. A user can enter braille data by embossing a dot in the braille display cell 700 by means of pushing the braille pin 702 down using a braille stylus 610. When a recessed dot is pushed further down, the braille pin 702 actuates the switch 721. The actuation or pressing of the switch 621 creates an electrical signal which can be read by an external microcontroller 420 to identify the dot embossed by the user. Once the user removes the stylus 610, the spring action of the switch 721 moves the braille pin 702 back to its original receded position. The switch 721 employed for this application can be a small tactile switch which on pressing by the braille pin 702 gives a tactile feedback which is mechanically relayed via the braille pin 702 and stylus 610 to the user, thereby via tactile means indicating to the user that an input has been registered. In another embodiment of the invention, the switch 721 could be a dome switch or an elastic membrane switch or any contact based mechanical input methods.

### Technical Advantage

The proposed invention has multiple points of novelties that provide great benefit not only in terms of enhanced usability but also in terms of cost, ease of manufacturing, assembly, quality check and repairability.

The electromechanical braille display cell system designed with the composite cam has a closed loop system integrated which outputs digital feedback indicating the binary state of every dot in the braille display cell, along with integrations for reading braille writing input entered by the user using a stylus. The closed loop system in the proposed invention which gives digital feedback indicating binary state of every dot can be implemented using cost effective parts and moreover the simplicity of the electromechanical systems employed eliminates failure points and improves reliability of the entire system. Digital feedback enables easy reading of feedback signals for a large number of dots present in a 20 or 40 cell braille display by simply reading a single bit digital value corresponding to each dot and eliminating the need for complex and expensive circuits needed to read a large number of analogue voltage channels. This greatly reduces the computational strain on the microcontroller allowing a refreshable braille display device to be built using a low end/entry level microcontroller. The closed loop system also ensures that any dot that fails to raise or recede during operation of the dot due to any external obstruction is immediately corrected for once the obstruction is removed. Braille readers have their fingers constantly running over the braille display as they read. It is often the finger of the user that obstructs movement of the dots that is being operated at that moment. The ability of the braille display to refresh or change states while the user is running their fingers over to read is very important to ensure users can read at their fast pace. Any dot that fails to raise or recede because of the user's finger, can be read and immediately corrected the moment the finger moves away from the dot. The proposed braille display cell therefore enhances user experience by allowing a user to read at their own pace while relaying dots accurately on the display. Refreshable braille displays are prone to failure wherein dots randomly stop working. This is importantly troublesome for users who are new to learning and reading braille. A user might not be able to identify a dot which has stopped working and they might end up reading or learning the character's dot combination incorrectly.

A braille display cell system built using the proposed braille display cell can detect any malfunction of the dots, can assist the user with troubleshooting and reduce the time to get the device to be reworked. An additional benefit of having a closed loop system in the braille display cell is that the entire process of quality checks during production of the braille display cell system may be automated. This facilitates faster and more accurate production methods ensuring that the braille display cell s can be manufactured in large quantities in the right quality.

Furthermore, a braille display cell system built using the proposed braille display cell, can leverage the proposed algorithm to go from one display state to another wherein the knowledge of true current state is achieved by the digital feedback and identifying and operating only those dots that have change of state between the two display states. The proposed algorithm greatly reduces the number of dots that need to be operated going from one display state to another. When draining power from a constrained source like a battery, having to operate a smaller number of dots at once, would therefore facilitate operation of a greater number of cells at the same time and thereby greatly increasing the refresh rate of the braille display cell system. Less power drained between display states, would also ensure that the device operated on battery will have a longer battery backup. The state of art fails to mention any algorithm like the one disclosed above.

The integration of elements that doubles up the braille display cell to also work as a braille writing apparatus opens up the possibility of multiple use cases. For example, in a 40-cell refreshable braille display cell system built using the proposed braille display cell, the first 20 cells from the left can be configured to work as braille display cells while the other 20 cells from the right can configured to read writing input from user entered via embossing dots using the stylus. This way, a user can write on the device using the 20 cells from the right, the same is being read by the microcontroller of the device which further gives signals to display the corresponding characters on the corresponding cell from the left side. This way a user can use the device to take notes by writing from the right side and simultaneously the same character is displayed on the left which the user can read in real time to ensure they have embossed the intended character correctly, and make any corrections if needed. In another application, all the 40 cells can be configured to work as a display allowing users to read more characters in a line when reading a book or a document. Further in a different application, all the 40 cells can be configured for writing input where the user can use a stylus to emboss dots across all the 40 cells for applications where they are for e.g. writing a long document or a student taking notes or writing an exam. State of art is silent about braille writing capabilities and therefore the cells cannot double up to provide any of the user functionalities stated previously.

Another intended benefit of integrating a means to read braille writing embossed by the user in the proposed braille display cell system, is that of increased reliability by eliminating starting torque load on the rotary actuator. The fact that the foot of the braille pin is floating above the curved profile face element of the composite cam, it rotates freely by a certain angle during the start which therefore eliminates any external starting torque load on the rotary actuator. Micro DC motors employed as rotary actuators here have inherently low operating torque output on their shaft. The external load of lifting a braille pin being eliminated during the start position and being gradually induced as the composite cam comes in contact with the foot of the braille pin, ensures smooth torque application on the rotary actuator. This greatly reduces failure because of insufficient starting torque by the rotary actuator and increases the overall reliability of the braille display cell system. The technology present in the state of art employs micro DC motors for raising and lowering pins that are completely silent on a provision like this which eliminates the starting torque demanded by the motor.

The present invention, therefore proposes a novel method to achieve a reliable braille display cell system which provides a digital feedback facilitating a low cost implementation with low computational requirements that can enable a stack of large number of cells to operate reliably with low power consumption and high refresh rate, along with capabilities of electrically reading input given by the user in the action of braille writing which is by embossing dots on the braille display cell using a stylus.

We claim:

1. A refreshable braille display cell system, comprising:
a cell case with a reading surface, the reading surface comprising a plurality of holes and guideways;
a plurality of braille pins, the plurality of braille pins comprising a tactile tip and a foot, wherein the foot comprises a planar surface extruding orthogonal to the length of braille pin;
a plurality of rotary actuators, the plurality of rotary actuators configured to rotate a shaft in clockwise and counter clockwise directions; and
a plurality of composite cam coupled to the shaft, the plurality of composite cam comprising a profiled curved surface configured to interact with the foot of the plurality of braille pins;
wherein rotation of the plurality of composite cam implement linear movement of the plurality of braille pins between a first and a second positional configuration.

2. The refreshable braille display cell system, as claimed in claim 1, wherein the plurality of composite cam comprises:
an offset radial extrusion extending radially outward in an orthogonal plane to the axis of the plurality of composite cam;
a plurality of proximity sensors, the plurality of proximity sensors configured to interact with the offset radial extrusion element;
wherein the plurality of proximity sensors generates a varying electrical signal indicative of rotational position of the plurality of composite cam, thereby detecting the position of the plurality of braille pins between a first and a second positional
configuration.

3. The refreshable braille display cell system as claimed in claim 2, wherein the offset radial extrusion comprises a curved concave face particularly designed to interact with the proximity sensor.

4. The refreshable braille display cell system as claimed in claim 2, wherein the refreshable braille display cell system comprises a closed-loop feedback mechanism.

5. The refreshable braille display cell system as claimed in claim 2, wherein the proximity sensor is an optical infrared emitter-receiver pair.

6. The refreshable Braille display cell system as claimed in claim 1, wherein the plurality of rotary actuators is configured to rotate the plurality of composite cam to a pre-defined angular position indicating the raised state and the recessed state.

7. The refreshable Braille display cell system as claimed in claim 1, wherein the refreshable Braille display cell system comprises a writing input mechanism, the writing input mechanism comprising:
a plurality of switches mounted on a printed circuit board; and
a plurality of braille pins engaged with the switches,
wherein the plurality of braille pin is engaged to actuate the switch when in the first positional configuration.

8. The refreshable Braille display cell system as claimed in claim 7, wherein a user registers the writing input by pushing the braille pin with a stylus, wherein the braille pin is engaged to actuate the plurality of switches generating an electrical signal readable by a microcontroller.

9. The refreshable Braille display cell system as claimed in claim 8, wherein the braille pin is engaged with the switch using a ‘L’ shaped side level pivoted to the cell case.

10. The refreshable Braille display cell system as claimed in claim 9, wherein a microcontroller is configured to detect the position of the braille pin and send corrective signals to actuate the plurality of braille pins failed due to obstruction.

11. The refreshable Braille display cell system as claimed in claim 1, wherein the refreshable Braille display cell system is configured to display a 6-dot Braille character or 8-dot Braille character.
